(19) United States
(12) Patent Application Publication
(10) Pub. No.: US 2012/0054119 A1
(43) Pub. Date: Mar. 1, 2012

(54) HEALTHCARE COST TRANSPARENCY SYSTEMS AND METHODS

(75) Inventor: Edward J. ZECCHINI, Scarsdale, NY (US)

(73) Assignee: INSUR I.Q. LLC., Shelton, CT (US)

(21) Appl. No.: 12/871,431

(22) Filed: Aug. 30, 2010

(51) Int. Cl. G06Q 99/00; G06F 17/30

(52) U.S. Cl. 705/347; 707/769; 707/E17.014

(57) ABSTRACT

Disclosed systems and methods provide healthcare cost transparency by enabling consumers to compare cost information for doctors, hospitals, and other healthcare providers before obtaining services. In some web-based server embodiments, a database is provided having available providers indexed by location and practice category. The database includes estimated costs for services from each provider, possibly based on past insurance claims submitted by each provider. A front end system provides access to the database, responding to requests for healthcare providers in a given location and practice category with lists that include an indication of costs charged by each of the listed providers relative to other providers. A user's selection of an individual provider may result in a detailed information page that includes a list of services and an estimate of the provider's fee for each service. The detail page may further include credentials, affiliations, ratings, reviews, and options to set an appointment.

### BACKGROUND

The spiraling costs of healthcare and health insurance result from a combination of factors, one of which is a lack of transparency. As a general rule, consumers are given the freedom to choose healthcare providers, but they are not provided with enough information to make cost-efficient choices. Healthcare providers generally do not publish their pricing information, which by itself makes it difficult for consumers to make informed decisions. To make things worse, the consumer is usually experiencing time pressure from the presence of some medical condition for which the consumer desires prompt treatment. Health insurance has, in the past, shielded most consumers from the impact of cost inefficiencies. As costs continue to grow, consumers are increasingly having to reckon with the financial consequences of their decisions.

### SUMMARY

Accordingly, there is disclosed herein web-based systems and methods that provide healthcare cost transparency by enabling consumers to compare cost information for doctors, hospitals, and other healthcare providers before obtaining services. Some system embodiments include a database having available providers indexed by location and practice category. The database further includes estimated costs for services from each provider, possibly based on past insurance claims submitted by each provider. A front end system provides access to the database, responding to requests for healthcare providers in a given location and practice category with lists that include an indication of costs charged by each of the listed providers relative to other providers. One suitable indication of relative costs might be the order in which the providers appear in the list, e.g., sorted in order from lowest cost to highest cost. Another suitable indication of relative cost might be a pictograph indicating whether the healthcare provider's costs are in a “lowest fees” category, a “below average” category, an “average” category, an “above average” category, or a “highest fees” category. In some system embodiments, the front end responds to a user's selection of an individual provider with a detailed information page that includes a list of services and an estimate of the provider's fee for each service. The detail page may further include credentials, affiliations, ratings, reviews, and options to set an appointment. Some healthcare cost transparency method embodiments include: receiving a request for information on providers in a given location; and responding with a list of suitable providers, the list including an indication of relative costs charged by individual providers in the list. The location may be specified in terms of an address or zip code and a proximity, e.g., a distance the user is willing to travel. The request may further specify a provider type (e.g., doctor, hospital, etc.) or practice category (e.g., general practitioner, orthopedic specialist).

### BRIEF DESCRIPTION OF THE DRAWINGS

A better understanding of the various disclosed embodiments can be obtained when the following detailed description is considered in conjunction with the following drawings, in which:

FIG. 1 shows an illustrative healthcare cost transparency services (HCTS) network;

FIG. 2 shows an illustrative HCTS system;

FIG. 3 shows an illustrative HCTS software architecture;

FIG. 4 shows an illustrative method for building an HCTS database;

FIG. 5 shows an illustrative method for providing HCTS; and

FIGS. 6-12 are illustrative HCTS screenshots.

While the invention is susceptible to various modifications and alternative forms, specific embodiments thereof are shown by way of example in the drawings and will herein be described in detail. It should be understood, however, that the drawings and detailed description thereof are not intended to limit the invention to the particular form disclosed, but on the contrary, the intention is to cover all modifications, equivalents and alternatives falling within the scope of the appended claims.

### DETAILED DESCRIPTION

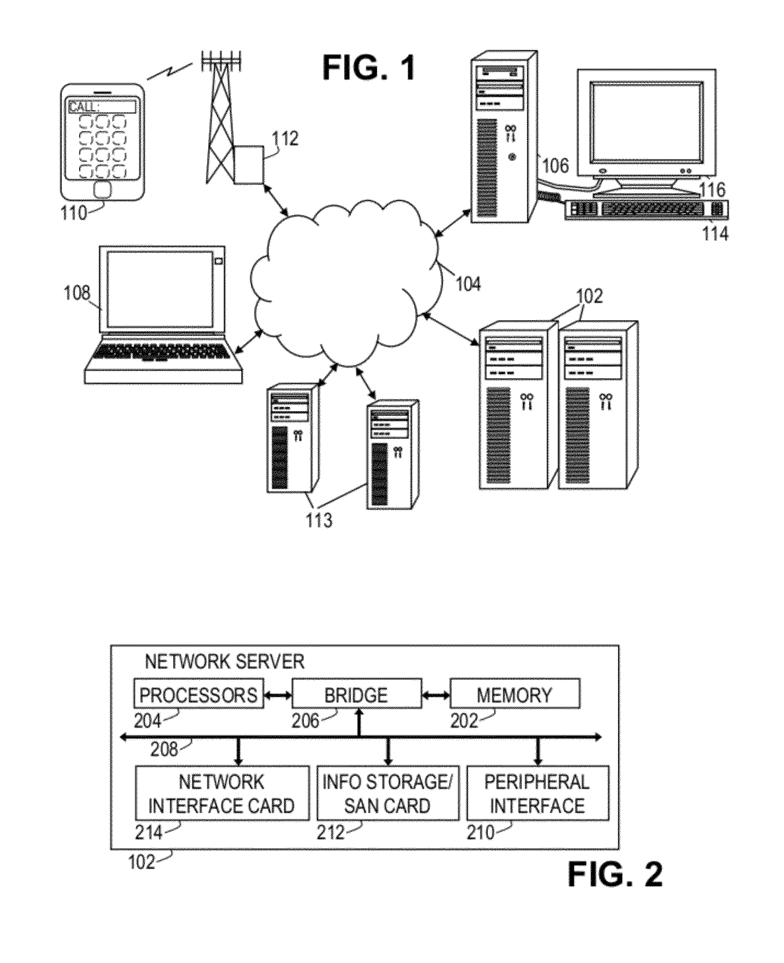

The disclosed systems and methods are best understood in terms of the context in which they operate. FIG. 1 shows an illustrative network environment in which healthcare cost transparency services (HCTS) may be provided. A set of one or more HCTS servers 102 is coupled to a computer network 104 such as the Internet. Consumers access the HCTS servers 102 from personal computers 106, laptops 108, mobile devices 110, or other network access points. The network 104 employs a hierarchy of interconnected routers, switches, and servers to transport communications between the various connected computers and devices having the appropriate network or web interfaces. Some devices (e.g., mobile device 110) are coupled to the network 104 via a cellular communications tower 112 and/or some other form of wireless link. Moreover, to couple to the network 104, modem-equipped devices may employ the plain old telephone services (POTS) network as an alternative or in addition to a wireless link.

Also shown in FIG. 1 are client servers 113. Servers 113 are owned by HCTS clients, e.g., an insurance company, a preferred provider organization (PPO), a network of healthcare providers (doctors and hospitals), a government agency, or a large employer. The servers 113 are sources of healthcare provider data including names and addresses of available doctors and hospitals, credentials and specializations of those providers, and cost information. The cost information can take any of a variety of forms such as, e.g., agreed fee schedules, historical claims data, “percentage off” agreements, and/or survey data.

We note here that the consumers are expected to employ access methods that enable interaction. For example, computer 106 has a keyboard 114 as a input device and a monitor 116 as an output device. The consumer can view information and options on monitor 116 and make selections or enter information, requests, and commands via the keyboard 114. Of course other user interface formats can be employed, including touch-sensitive screens, pointing devices, motion recognition, voice input, haptic devices, speakers, and printers. Moreover, computer 106 typically includes information storage resources such as a hard disk, an optical disk, and/or nonvolatile memory, each of which can be used to store input and/or output for later use and re-use.

FIG. 2 is a functional block diagram of an illustrative HCTS server 102 that provides some portion or combination of the functions outlined further below. The server 102 includes a memory 202, one or more processors 204, and a high-speed bridge that connects the processor(s) 204 with the memory 202 and the expansion bus 208. The expansion bus 208 supports communication with a peripheral interface 210, information storage device 212, and a network interface card 214.

Peripheral interface 210 provides input/output (I/O) ports for communicating with external devices such as keyboards, mice, universal serial bus (USB) devices, printers, cameras, speakers, etc. On many servers, these ports may be left largely unused, but they are nevertheless available for configuration, diagnostic, and performance monitoring purposes. Information storage device 212 is typically a nonvolatile memory for firmware or a hard drive for extended storage of software and data. On distributed systems with high data availability requirements, the information storage device 212 is replaced or supplemented with a storage area network (SAN) card that enables shared access to a large disk array. A network interface card 214 provides access to other network servers and usually to the Internet as a whole.

Before the illustrative server 102 is brought into service, the relevant HCTS software components are stored on the local hard drive 212, or sometimes on a network disk accessible via the network interface card. After the initial boot-up diagnostics are completed, the processor(s) load the HCTS software components into memory, either all at once or on an “as needed” basis (e.g., by paging the needed instructions into memory). As the processor(s) execute the software instructions, the software configures the operation of the illustrative server(s) in accordance with the methods and principles set forth herein.

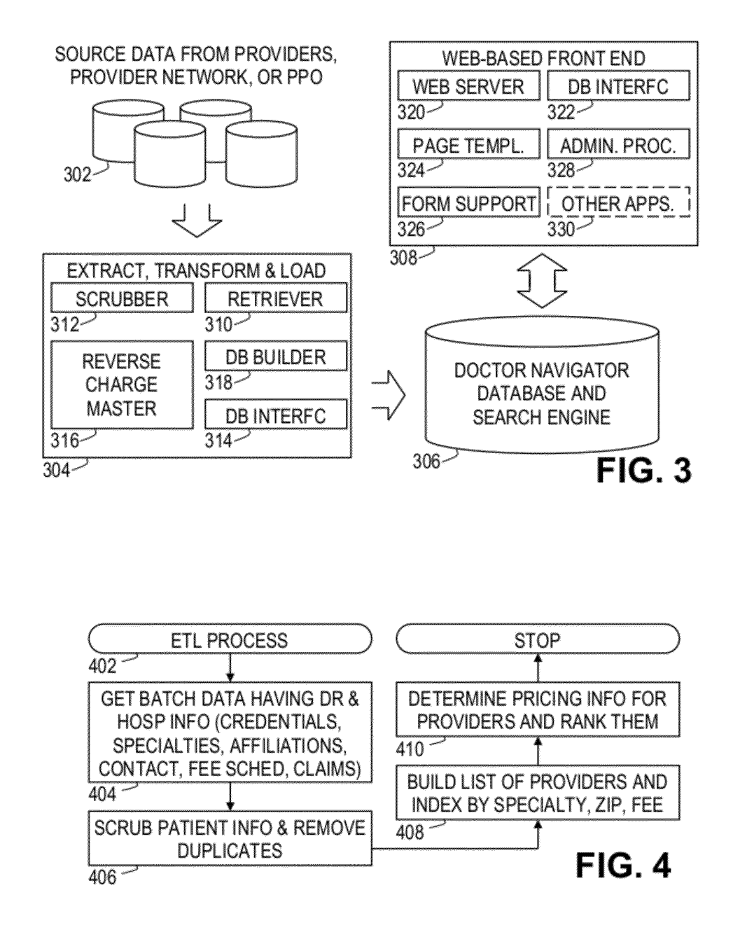

FIG. 3 is a function block diagram of illustrative HCTS software. Though numerous independently executing processes exist, they can be grouped into four functional groups: the source data group 302; the extract, transform & load (ETL) group 304; the database 306; and the front end 308. These will be addressed in order, and initially at a high level. Thereafter, a more detailed discussion will be provided regarding a number of the more pertinent methods carried out by the HTCS system.

The source data group 302 represents the client databases that contain the relevant information. Of course the nature and form of the available data will vary from client to client, and it is desirable to transform that data into a consistent format for use by the rest of the HCTS system. When the client is a network of healthcare providers such as a preferred provider organization, the data may be expected to include names, locations, and contact information for various doctors and medical care facilities, along with agreed fee schedules for each doctor or facility in the list. The data may further include credentials, specializations, and affiliations (e.g., which doctors have admitting privileges at a given hospital). When the client is a large employer or government agency, the data may be expected to be primarily claims data from which most of the other information can be reconstructed. A survey organization may be employed to fill in the data gaps, e.g., provider credentials. When the client is an insurer, both types of information may be available. The source data can be made available to the HCTS servers via the network 104, or the data can be delivered on physical information storage media to the HCTS servers.

In addition to client databases, data can also be obtained from third parties. For example, credentials and affiliations may be obtained from certification agencies and/or government registration systems. Pharmaceutical pricing information may be obtained from a commercial database service. Provider ratings can be obtained through a service provider dedicated to collecting and providing such information. In short, the source data can be collected from a wide range of sources.

The ETL group 304 is the set of processes that retrieve and process the source data to build the database 306. Those skilled in the art will recognize that there are existing enterprise integration and ETL frameworks that can be adapted for use in the HCTS system, including CloverETL, IBM InfoSphere DataStage, Oracle Data Integrator, Ab Initio Software, and others. The ETL group 304 includes a retriever process 310 that is programmable to pull data in a robust, systematic manner from the source data and feed it in a standard format to the scrubber process 312 or to the database interface process 314. The retriever process 310 is configured to shield the rest of the ETL group from problems such as data corruption, interruptions in data transfer, and dynamic changes in the source data. The scrubber process 312 operates on the data stream if needed to remove any information that would identify individual patients, optionally replacing such information with arbitrary identifiers or generic entries. The scrubber process 312 may further identify and remove duplicated data.

The database interface process 314 feeds the processed data into the database 306 as a table of providers with supporting information such as location, credentials, specializations, affiliations, and cost information. In some cases, the cost information is not a direct fee schedule. In such instances the reverse charge master 316 performs post-processing on the database to construct an estimated fee schedule. Thus, for example, where the cost information is stated in the form of a fixed percentage of some standard or average fee (or alternatively a fixed discount percentage off of the standard or average fee), the reverse charge master obtains such standard or average fee information or applies a statistical analysis to estimate it. Once each provider has cost information associated with it, the database builder process 318 constructs a set of index tables in the database to organize the providers by location, specialization, and fee structure.

Front end 308 includes a web server 320, a database interface process 322, a set of page templates 324 and support processes 326, an administrative interface process 328, and optionally some other applications 330. The database interface process 322 establishes a connection to the database software 306 to assure coherent and reliable database access for the other front end processes. The web server component 320 responds to consumer interactions with web pages constructed from the appropriate templates 324, which generally include graphics and text indicating the desired user input, fields to accept that input, and rules or software for processing that input. Form support software 326 can process the user input to extract the relevant information and form a relevant query to the database. For example, the support software can take address information and extract the relevant portion of a zip code, and/or it can provide more sophisticated processing to compute distances from a given address to each of the results returned by the database. The administrative interface process 328 provides a web-based mechanism for administrators to log in and monitor system operations. Other applications 330 can be provided to obtain grant access to third party services including, for example, physician ratings, services to obtain appointments, and or follow-up surveys to determine patient satisfaction. Educational materials, blogs, and/or forums for consumer interaction can be similarly provided.

FIG. 4 shows an illustrative ETL method 402 that can be carried out by the ETL process group 304. Beginning with block 404, the HCTS servers obtain health provider data from the client. To the extent that the data includes information that would identify individual patients, the servers filter out the identifying information in block 406. At the same time, the servers can reformat the data and delete any duplicative entries. In block 408, the servers build a list of health care providers in the database and index them by specialty, location, and fee structure. In block 410, the servers augment the healthcare provider list with pricing information. The pricing information is set in a form that simplifies comparison between providers and makes it possible to rank the providers by price. Thus, for example, a given doctor's typical charge for an initial office visit can be derived from past insurance reimbursement claims made by that doctor, or the information could come from an agreed fee schedule provided by that doctor. Alternative sources for an agreed fee schedule include an organization, network, or other contracted entity that represents the doctor as part of a group.

While most providers tend to subscribe to a fixed discount price schedule, a substantial fraction of providers prefer a “percent-off” agreement, i.e., an agreement where they offer a fixed percentage discount off of their standard rates. Because percent-off agreements allow providers to change their standard rates at any time, it becomes more difficult to ascertain estimated costs for such providers. Some system embodiments analyze past insurance claims from such providers to determine actual charges for those services which have been provided. Because a provider's services list that is derived in this manner tends to be incomplete, the available numbers are matched against fixed discount price schedules for other providers in the area. If there is a close match, that fixed discount price schedule is used to fill the gaps in the provider's list of estimated service costs. If there are no close matches, the system can attempt to derive ratios between service costs to determine whether a good match can be achieved with scaled versions of the fixed discount price schedules. Interpolations (i.e., weighted sums) of fixed discount price schedules can also be examined in an attempt to find a good match. Failing that, the provider's price information may be omitted from the database or obtained by other means (e.g., by sending a questionnaire to the provider).

Once estimated costs have been determined for each type of service offered by each provider, those costs may be combined as a weighted sum to determine a single cost number representing how expensive that provider's services are. (More common services would be weighted more heavily than rarely-provided services.) The cost numbers for all providers in a given category (e.g., in a given three-digit zip code and specialty) can be analyzed to determine an average cost number and standard deviation. The providers can then be categorized as being “average” (e.g., within plus or minus one half standard deviation of the average), “expensive” (e.g., more than one standard deviation above the average), “inexpensive” (e.g., more than one standard deviation below the average) or in an intermediate category such as “somewhat expensive” or “somewhat inexpensive”. Of course other comparative methods and categorizations can be used. The goal is to provide consumers with an easy-to-understand representation of the relative financial impact created by employing one provider versus another.

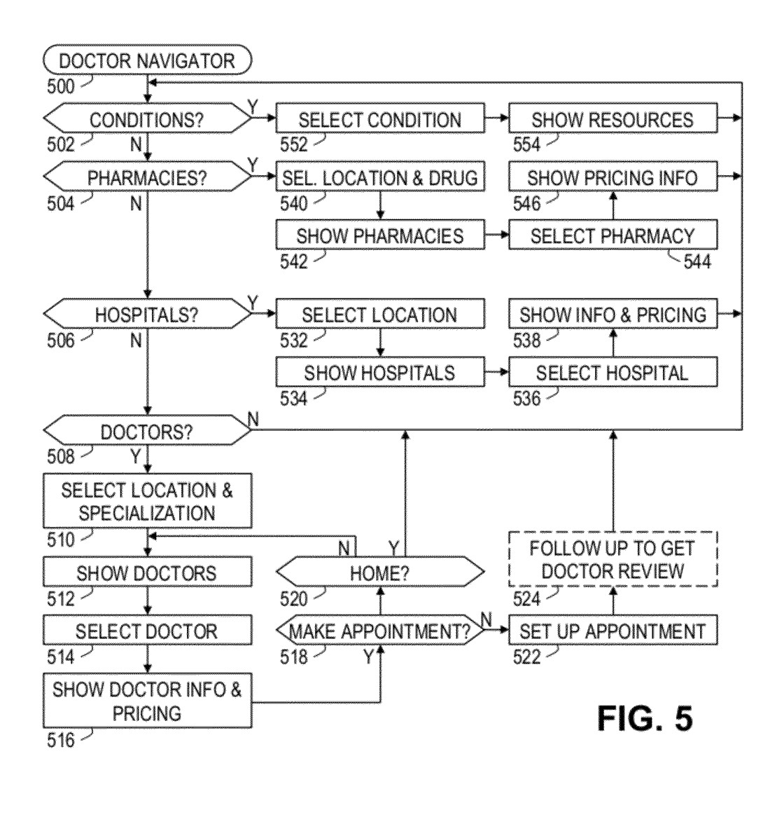

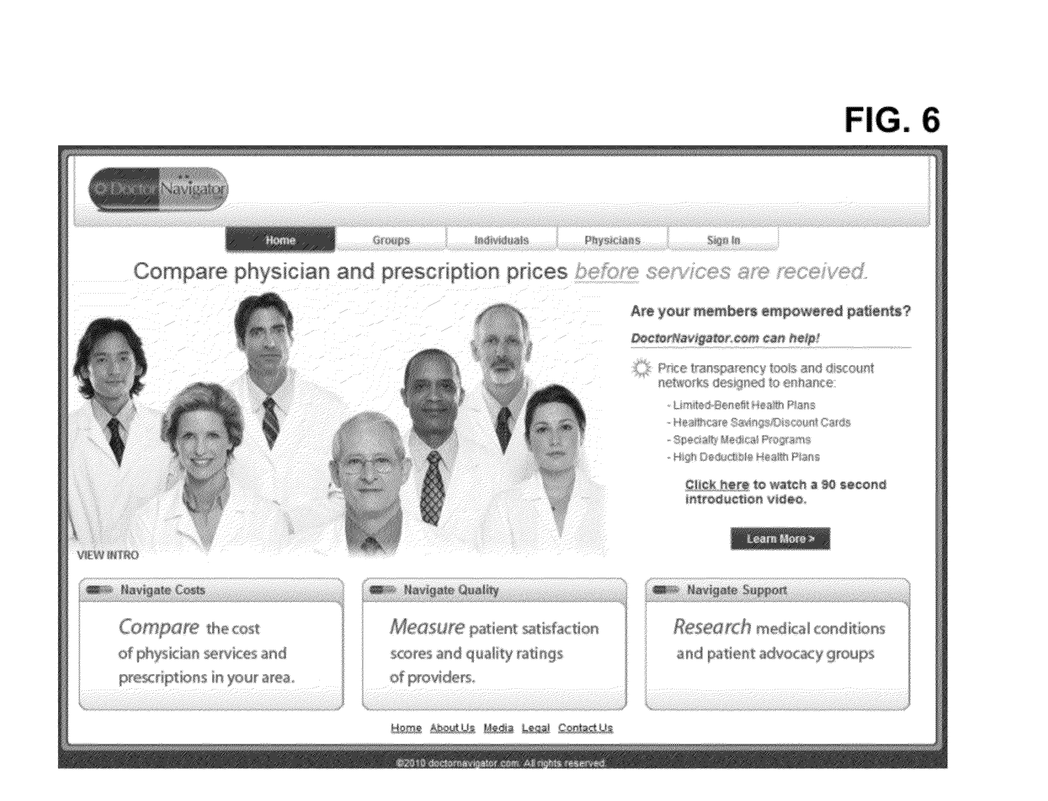

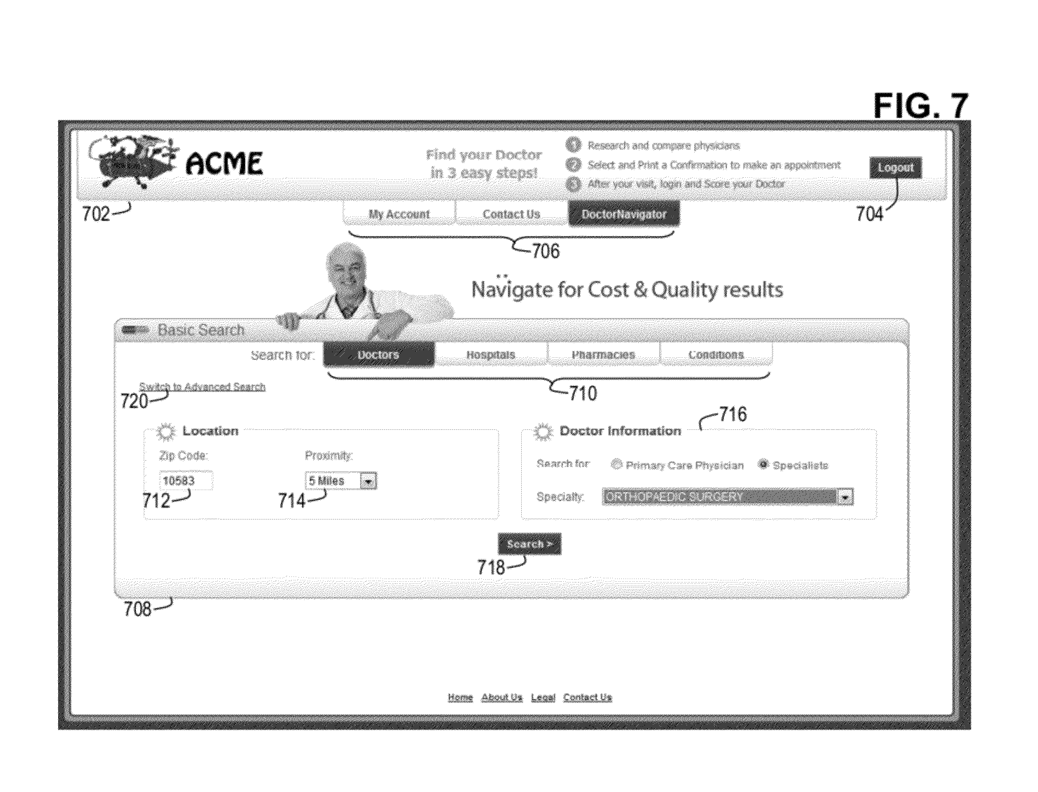

FIG. 5 shows an illustrative method 500 for providing HCTS. A consumer can initiate the process by accessing a home web page such as that shown in FIG. 6. The home page offers consumers the opportunity to learn more information about HCTS and, if they are in a program provided by an HCTS client, they can “sign in” by providing a user name and password. Providers and potential clients can also employ the home page to learn more about HCTS. The “signing in” process enables the HCTS servers to determine which healthcare provider database should be consulted during the HCTS process. As this discussion proceeds through the illustrative method in FIG. 5, reference will be made to various other figures that show illustrative web pages that might be viewed by a consumer as they work their way through the process.

FIG. 7, in particular, shows an illustrative search page that might be viewed by a consumer immediately after signing in. The search page includes a banner 702 showing a client logo or other information identifying the sponsor that provided the consumer with access to the HCTS, and further includes a consistently-placed “Logout” button 704 that enables the consumer to exit from the process at any time. Immediately underneath the banner 702 is a set of tabs 706 that enable a customer to modify their account information (e.g., user name and password), to contact the HCTS provider, and to initiate the search portion of the HCTS. This last tab may be labeled “DoctorNavigator” or some other descriptive phrase, and it may be selected by default after a consumer signs in. A search window 708 includes tabs 710 to select whether the search should be for doctors, hospitals, pharmacies or medical conditions. With the doctor option selected, the search window 708 provides entry fields for specifying the search location 712 and proximity 714. The search location 712 can simply be a zip code or, if the advanced search option 720 is selected, a specific address or intersection. The proximity field 714 can specify an acceptable travel distance from the search location, e.g., 5 miles. Search window 708 further includes a doctor information region 716 where the consumer can specify whether the doctor should be a primary care physician or a specialist, and if the latter, what type of specialist. Once the various fields have been populated, the consumer selects the “Search” button 718.

Having responded to the consumer sign in with a web page such as the one shown in FIG. 7, the server analyzes the web page request(s) that result from the consumer's entry of data and manipulation of links or widgets (such as buttons, sliders, radio buttons, etc.). As part of this analysis, the server determines in blocks 502-508 (FIG. 5) whether the consumer wishes to search on medical conditions, pharmacies, hospitals, or doctors. The process loops through these blocks or waits in some other fashion until some request or selection is made. Of course, other options would typically be included, such as checking for a “sign out”, a switch to advanced search mode, or a request for help information on the available options.

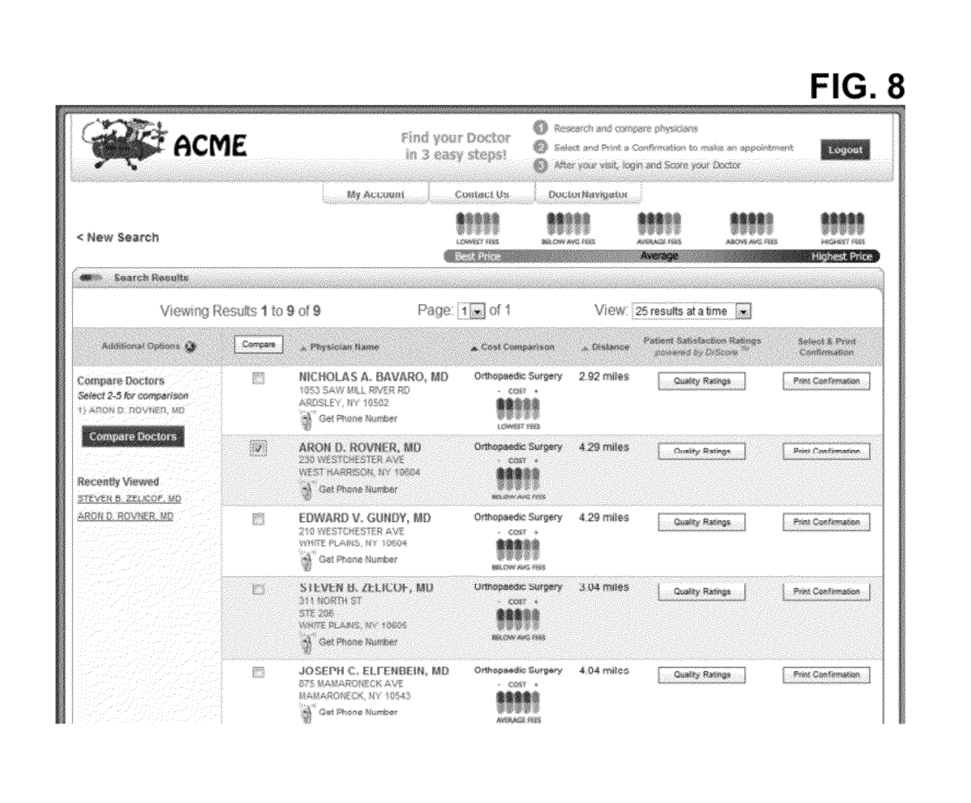

If the consumer elects to perform a doctor search, the web page displays a search window such as window 708 (FIG. 7), which enables the consumer to enter or select location, proximity, and doctor specialization information. The HCTS server processes this information in block 510 to formulate a database query and obtain a list of the relevant doctors. In block 512, the server places the list of doctors into a web page format and sends it to the consumer. The list is preferably sortable according to consumer criteria, and may be sorted by default from lowest average cost to highest average cost. An illustrative example of one such page is provided in FIG. 8.

FIG. 8 shows a list of doctors that satisfy the search criteria. Note that the format and content of the list can be customized to suit the client. The illustrative list includes six columns, one of which is the doctor's name and address information, a second of which is a “cost comparison” showing an indicator of the relative amount that doctor charges for medical care, a third of which is a distance from the consumer-specified location, and a fourth of which is a “Print Confirmation” button that provides an easy way for the consumer to select that doctor, obtain an appointment, and receive a printed confirmation. (In addition to details regarding the appointment time, doctor's location, and phone number, the printed confirmation may include information about the consumer. Such information can include the consumer's name, address, phone, and relevant insurance information, thereby enabling the consumer to easily communicate that information to the doctor by handing them the printed confirmation.) Of the remaining two columns, one provides a button that retrieves rating information to provide an indication of the quality of care provided by the doctor, and the other column is a set of check boxes that enable the consumer to select multiple doctors from the list for a side-by-side comparison.

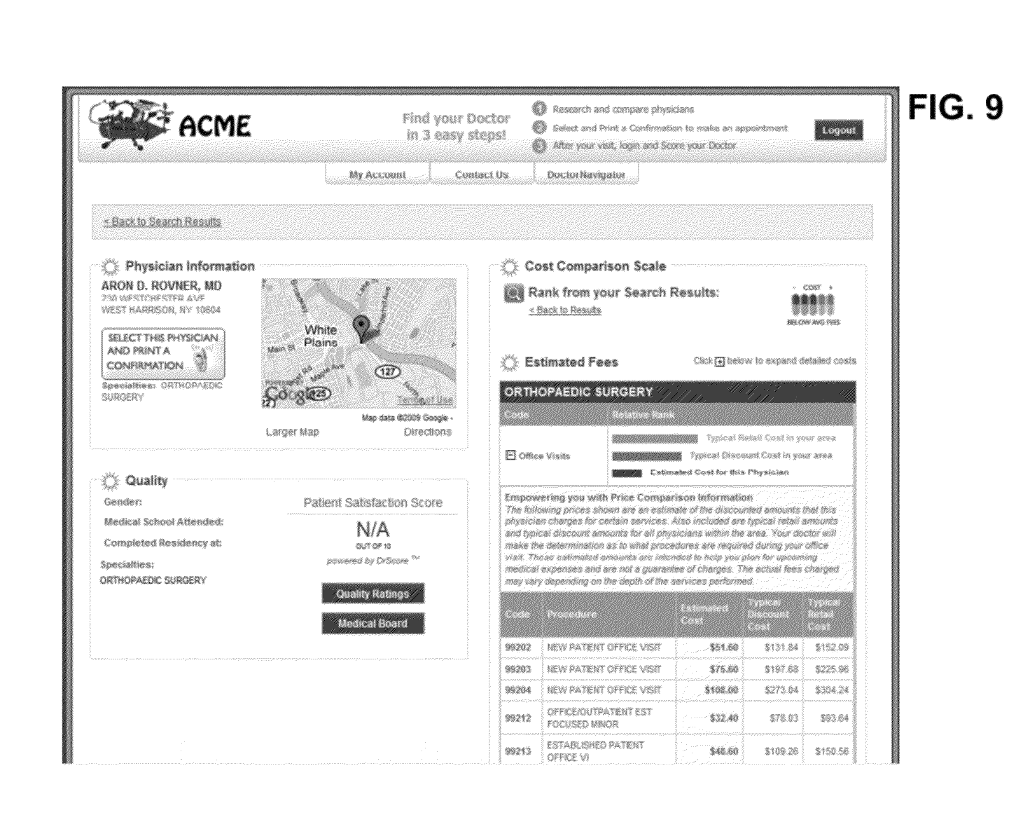

If the consumer selects one of the entries in the list, the server in block 514 (FIG. 5) processes the selection to formulate a database query and obtain detailed information about that doctor. In block 516, the server formulates a web page with the results from the database and sends it to the consumer. One example of such a page is shown in FIG. 9. Again, the format and content can be customized to suit the client. The illustrated doctor information screen includes the doctor's contact information, specializations, affiliations, and credentials. It also includes a map showing the doctor's location, with options to obtain directions and a larger map. Some of this information can be obtained in real time from third party services including, for example, maps and driving directions, provider ratings and reviews, and services to set up and calendar an appointment for the patient. In some embodiments, the server collects much of this information from a variety of information providers and services in real time to present an aggregated display to the user.

In the illustrated example, a “Patient Satisfaction” rating is provided based on ratings from other consumers, with buttons that enable the consumer to see reviews from other consumers and to see any public information available from the appropriate Medical Board. Also included is a relative cost score for the doctor, along with a list of categories for medical services provided by the doctor. The consumer can select a category (e.g., office visits) to see the estimated costs to the consumer for specific service codes within that category. Optionally, the screen can also provide cost comparisons. For example, the illustrated example includes a column for the typical retail price for such services and the typical discounted cost for such services. The typical retail price can be obtained from a commercially available database of “usual and customary” prices for medical services. The typical discounted cost can be derived from other doctors within the area having similar specializations. In some embodiments, a column is included to show the prices authorized by Medicare/Medicaid. The cost information may be accompanied by a disclaimer indicating that the costs are estimates and subject to change based on the doctor's evaluation of the situation.

We note that in some implementations, the system has access to patient insurance records and is able to determine insurance factors such as a patient's deductible, co-pay, co-insurance rate, and year-to-date out-of-pocket costs. For example, when the client is an insurance company, the client's servers can make this information accessible in real time to the front end server. When such insurance factors are available, the front end can also apply the terms of the insurance policy to display an estimate of the consumer's out-of-pocket cost for each listed service.

As with the list of doctors, the detailed information screen may include a “Select and Print Confirmation” button that obtains appointment information and provides it in printed form to the consumer. The server carries out these functions in blocks 518 and 522 (FIG. 5). Of course the consumer may decide to evaluate other doctors or redo the entire search, which option the server handles in block 520. If the consumer does choose to make an appointment, the server may schedule a follow-up message to the consumer to obtain a consumer review of that doctor in block 524.

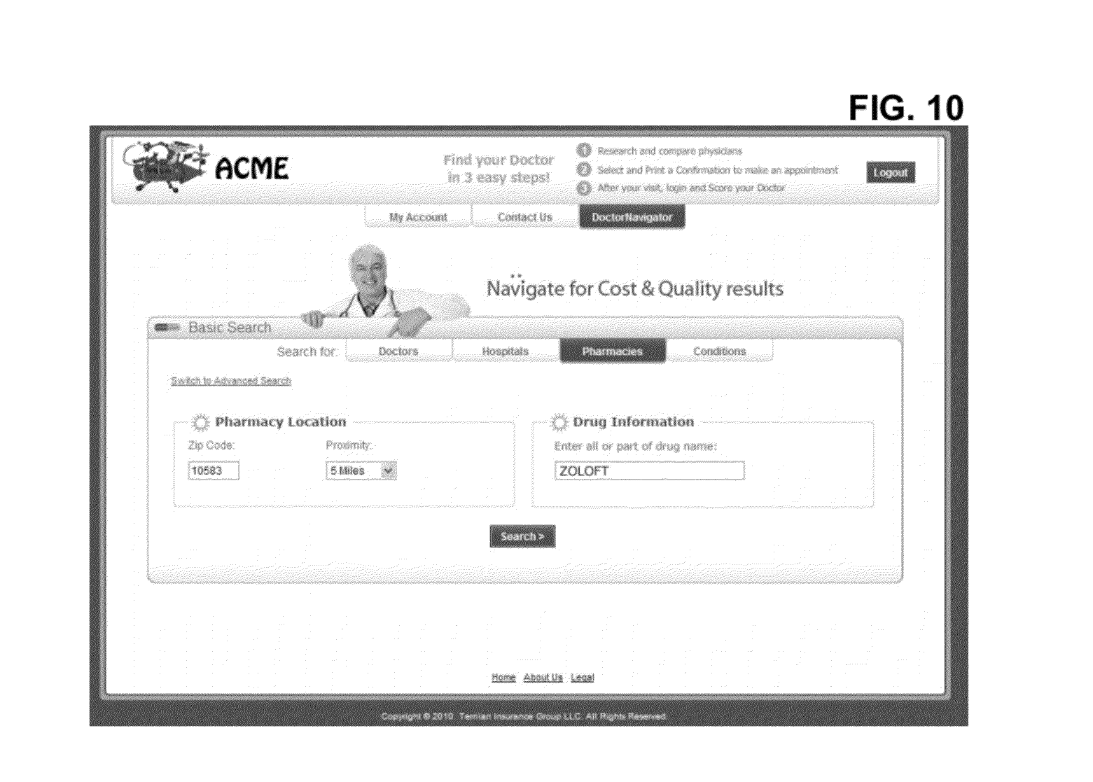

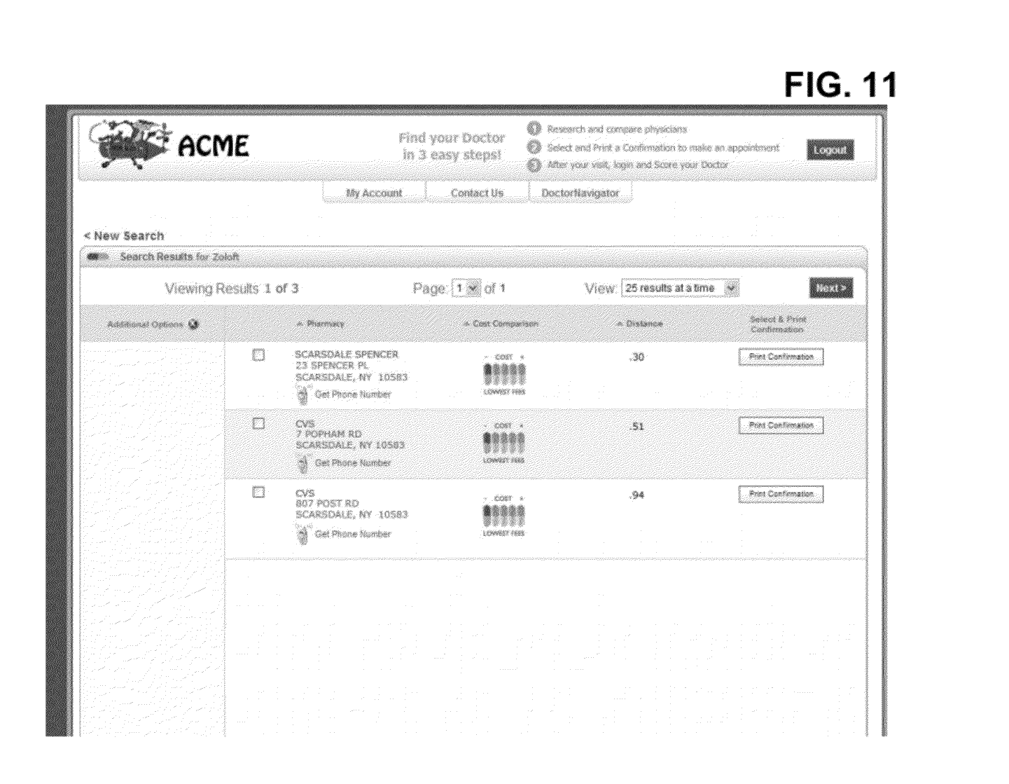

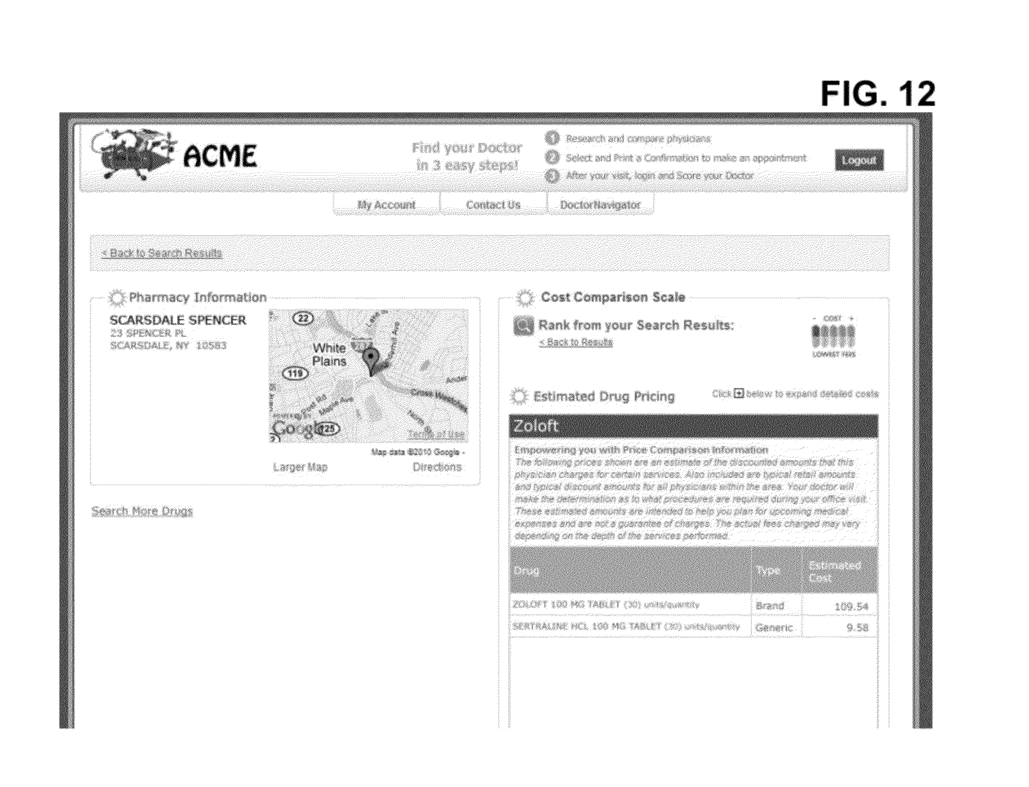

If the consumer instead searches for hospitals, the server executes blocks 532-538 to determine the consumer's location information and show a list of hospitals in the area, which the consumer can select and evaluate in a similar fashion as before. Similarly, if the consumer searches for a pharmacy, the server accepts location and proximity information, along with some identification of the desired prescription drug in block 540 using a search screen such as that shown in FIG. 10. The server in block 542 (FIG. 5) determines the pharmacies in the database that satisfy the query and lists them in a web page format such as that shown in FIG. 11. The screen in FIG. 11 shows name, address and phone information for the various pharmacies, along with cost and distance information and a “Print Confirmation” link to request that the selected pharmacy fill a prescription. (If the “Print Confirmation” link is selected, the server makes the request and provides a printable confirmation form that specifies when the prescription can be picked up, along with directions or other information to assist the consumer.) In block 544 the consumer selects an entry in the list to review detailed information about the pharmacy and its drug pricing. In block 546 the server processes the selection to provide a detailed information page such as that shown in FIG. 12. The detailed information page can include address, map, and direction information, consumer reviews, and other information about the pharmacy in addition to estimated drug pricing. If a brand name drug has a generic equivalent, the pricing information for the generic is also provided. The pricing information includes the name of the drug, the dosage and quantity, and the price. In some embodiments, the server enables the consumer to fill a prescription “basket” with the appropriate combination of prescribed drugs and to perform comparison pricing based on the total price for the basket.

Finally, the server determines in block 502 whether the consumer is searching for resources for a particular medical condition. In block 552 the server processes the name or keywords for the condition from the search page to formulate a database query, and displays a list of the relevant resources in block 554. Such resources can include specialist clinics for rare diseases, experimental treatments and research programs, educational materials and/or support group information.

Numerous variations and modifications will become apparent to those skilled in the art once the above disclosure is fully appreciated. For example, at least some of the described embodiments collect and process source data beforehand, but in certain contemplated alternative embodiments, the source data is collected and processed in real time, i.e., in response to a consumer inquiry. As another example, at least some of the described embodiments rely on the first three digits of a zip code to specify a location, but in certain contemplated alternative embodiments, the location can be specified in a variety of ways including, e.g., a latitude-longitude geocode, a street intersection, a landmark, or a fully specified address. It is intended that the following claims be interpreted to embrace all such variations and modifications.

What is claimed is:

1. A healthcare cost transparency method that comprises:
receiving a request for provider information, wherein the request indicates a geographic search location; and
providing a response that includes a list of providers that provide services proximate to that location,
wherein the response provides an indication of relative costs charged by individual providers in the list.

2. The method of claim 1, wherein the response is formatted for display as a web page.

3. The method of claim 1, wherein the request further indicates a practice category, and the list includes only providers in that practice category.

4. The method of claim 3, wherein the indication of relative cost is a measure of a direction and degree by which the provider's costs deviate from an average for providers in that location and practice category.

5. The method of claim 1, wherein the indication of relative cost is a measure of a direction and degree by which the provider's costs deviate from those of other providers in that location.

6. The method of claim 1, further comprising:
receiving a selection of a provider in the list; and
displaying provider information that includes various services provided by the provider and an estimated cost for each service.

7. The method of claim 6, wherein the provider information further includes at least one representation of patients' ratings or satisfaction with that provider.

8. The method of claim 6, wherein the provider information further includes the provider's credentials and affiliations.

9. The method of claim 1, wherein the list of providers includes doctors.

10. The method of claim 1, wherein the list of providers includes hospitals.

11. The method of claim 1, wherein the list of providers includes pharmacies.

12. A healthcare cost transparency system that comprises:
a database of healthcare providers indexed by location and practice category, wherein the database further includes estimated costs for services from individual healthcare providers;
a front end that responds to requests for healthcare providers in a given location and practice category, wherein at least some of the responses include a list of healthcare providers with an indication of costs charged by individual healthcare providers relative to other healthcare providers.

13. The system of claim 12, wherein the response is formatted for display as a web page.

14. The system of claim 12, wherein said other healthcare providers each provide healthcare services proximate to the given location.

15. The system of claim 14, wherein the indication includes a sorted order of the list.

16. The system of claim 14, wherein the indication includes a pictograph indicating whether the healthcare provider's costs are in a “lowest fees” category, a “below average” category, an “average” category, an “above average” category, or a “highest fees” category.

17. The system of claim 12, wherein the front end further responds to selections of an individual healthcare provider, the selection responses including a list of services and an estimated cost for each service.

18. The system of claim 17, wherein the estimated cost is an out-of-pocket cost that accounts for a user's deductible and co-insurance rate.

19. The system of claim 17, wherein the selection responses further include consumer reviews of the healthcare provider.

20. The system of claim 12, wherein the front end also responds to requests for prescription drug information with prices charged by one or more pharmacies in a specified location.

21. The system of claim 12, wherein the list includes an icon for each healthcare provider in the list, and wherein the front end responds to an actuation of the icon by providing appointment information formatted for printing.
